(19) United States
(12) Patent Application Publication
(10) Pub. No.: US 2025/0145415 A1
(43) Pub. Date: May 8, 2025

(54) METHOD AND APPARATUS FOR DETECTING AUTOMATIC CLOSING FUNCTION OF A FLOOR DOOR

(71) Applicant: Otis Elevator Company, Farmington, CT (US)

(72) Inventors: Qing Wu, Shanghai (CN); Xiaobin Tang, Tianjin (CN); Xiaping Qiu, Shanghai (CN)

(21) Appl. No.: 18/929,802

(22) Filed: Oct. 29, 2024

(30) Foreign Application Priority Data
Nov. 2, 2023 (CN) 202311455861.4

(51) Int. Cl. B66B 13/14; B66B 5/00; B66B 13/18

(52) U.S. Cl. CPC B66B 13/146; B66B 5/0025; B66B 13/185

(57) ABSTRACT

A method and device for detecting an automatic closing function of a landing door, an elevator system and a non-transitory computer-readable storage medium. In the method for detecting the automatic closing function of the landing door, when a car of an elevator system stops at one of a plurality of floors, a car door of the car and a landing door associated with one of the plurality of floors are opened. Subsequently, during a closing process of the landing door, a drive mechanism of the elevator system is caused to apply a balanced driving force to the car door of the car. The balanced driving force corresponds to resistance to which the car door is subjected. Next, it is determined whether the associated landing door can be closed normally within a preset time period since the start of applying the balanced driving force to the car door.

### FOREIGN PRIORITY

This application claims priority to Chinese Patent Application No. 202311455861.4, filed Nov. 2, 2023, and all the benefits accruing therefrom under 35 U.S.C. § 119, the contents of which in its entirety are herein incorporated by reference.

### TECHNICAL FIELD OF INVENTION

The present application relates to elevator maintenance technology and, in particular, to a method and device for detecting an automatic closing function of a landing door, an elevator system comprising the device, and a non-transitory computer-readable storage medium storing a computer program for implementing the method.

### BACKGROUND OF THE INVENTION

When an elevator car is running or a landing door is not properly closed, the landing door will be locked or closed automatically with the help of a self-locking function or an automatic closing function to reduce the risk of accidents. Currently, the check of the automatic closing function of the landing door is still manually completed. For example, maintenance personnel regularly or irregularly test the automatic closing function of the landing door on each floor one by one to determine whether its function is normal. The check work will take a large amount of labor and time, especially for elevator systems operating in high-rise and ultra-high-rise buildings.

### SUMMARY OF THE INVENTION

In accordance with an aspect of the present application, there is provided a method for detecting an automatic closing function of a landing door. In the method for detecting the automatic closing function of the landing door in accordance with an aspect of the present application, when a car of an elevator system stops at one of a plurality of floors, a car door of the car and a landing door associated with one of the plurality of floors are opened. Subsequently, during a closing process of the landing door, a drive mechanism of the elevator system is caused to apply a balanced driving force to the car door of the car. The balanced driving force corresponds to resistance to which the car door is subjected. Next, it is determined whether the associated landing door can be closed normally within a preset time period since the start of applying the balanced driving force to the car door.

Optionally, the method performs the above steps in a specified order for landing doors associated with one or more other floors of the plurality of floors.

Optionally, the method further comprises sending a detection report on the automatic closing function of the landing door of the one or more landing floors to cloud or a mobile terminal.

Optionally, in the method, further comprising: determining whether the elevator system is adapted to enter or be in a test mode, and if so, performing the above steps.

Optionally, the balanced driving force is adjusted based on a position of the car door during an application of the balanced driving force to the car door. Further, the balanced driving force is adjusted only after the car door reaches a position at which its self-locking mechanism starts to act. Still further, the balanced driving force is adjusted in such a way that the balanced driving force makes a stepwise jump, magnitude of the jump being determined based on amount of change in the position of the car door and peak value of the resistance to which the car door is subjected during the act of the self-locking mechanism, amount of change in the position of the car door during the application of the balanced driving force.

Optionally, in the method, further comprising: obtaining a relationship curve between the balanced driving force and the position of the car door. Further, the relationship curve may be determined in the following manner: decoupling the car door from the landing door mechanically and causing the car door to move at a constant speed by controlling a driving force applied by the drive mechanism to the car door, and subsequently obtaining the relationship curve based on the applied driving force and the corresponding position of the car door. Furthermore, the relationship curve may be calibrated regularly or irregularly.

Optionally, determining whether the self-locking mechanism starts to act is based on at least one of: a sensing signal from a sensor monitoring a movement of the self-locking mechanism, a current flowing through the self-locking mechanism and a signal from a position feedback device of the self-locking mechanism.

Optionally, the preset time period is determined based on speed of movement and position of the landing door at the beginning of applying the balanced driving force.

Optionally, the balanced driving force is applied from the start of the closing process or from a moment after the start of the closing process.

A device for detecting an automatic closing function of a landing door of an elevator system in accordance with another aspect of the present application comprises a memory, a processor coupled with the memory, and a computer program stored on the memory and running on the processor. The running of the computer program results in the following operations: opening a car door of the car and a landing door associated with one of the plurality of floors when a car of the elevator system stops at one of a plurality of floors; causing a drive mechanism of the elevator system to apply a balanced driving force to the car door of the car during a closing process of the landing door, wherein the balanced driving force corresponds to resistance to which the car door is subjected; and determining whether the associated landing door can be closed normally within a preset time period since the start of applying the balanced driving force to the car door.

An elevator system in accordance with another aspect of the present application comprises: landing doors provided at a plurality of floors, a car, a drive mechanism and a control device. The landing door has an automatic closing function. The control device comprises a memory, a processor coupled with the memory, and a computer program stored on the memory and running on the processor. The running of the computer program results in the following operations: opening a car door of the car and a landing door associated with one of the plurality of floors when a car of the elevator system stops at one of a plurality of floors; causing a drive mechanism of the elevator system to apply a balanced driving force to the car door of the car during a closing process of the landing door, wherein the balanced driving force corresponds to resistance to which the car door is subjected; and determining whether the associated landing door can be closed normally within a preset time period since the start of applying the balanced driving force to the car door.

In accordance with a further aspect of the present application, there is provided a computer-readable storage medium on which a computer program suitable for running on a processor of a terminal device is stored, the running of the computer program resulting in the steps of the method as described above being performed.

### BRIEF DESCRIPTION OF THE DRAWINGS

The above and/or other aspects and advantages of the present application will be clearer and more easily understood from the following description of various aspects in conjunction with the accompanying drawings, in which the same or similar units are denoted by the same reference numerals. The accompanying drawings include:

FIG. 1A exemplarily shows a relationship curve of resistance to which a car door is subjected versus its position.

FIG. 1B exemplarily shows a relationship curve of a balanced driving force applied to a car door versus a position of the car door.

FIG. 2 is a flowchart of a method for detecting a function of an elevator system in accordance with some embodiments of the present application.

FIGS. 3A-3C are schematic diagrams of states of a car door and a landing door of an elevator system.

FIG. 4 is a schematic block diagram of a device or detection device for detecting a function of an elevator system in accordance with some other embodiments of the present application.

FIG. 5 is a schematic block diagram of an elevator system in accordance with some other embodiments of the present application.

### DETAILED DESCRIPTION OF THE INVENTION

The present application is described more fully below with reference to the accompanying drawings, in which illustrative embodiments of the application are illustrated. However, the present application may be implemented in different forms and should not be construed as limited to the embodiments presented herein. The presented embodiments are intended to make the disclosure herein comprehensive and complete, so as to more comprehensively convey the protection scope of the application to those skilled in the art.

In this specification, terms such as “comprising” and “including” mean that in addition to units and steps that are directly and clearly stated in the specification and claims, the technical solution of the application does not exclude the presence of other units and steps that are not directly or clearly stated in the specification and claims.

In this specification, “closing process” refers to a process in which a car door or landing door begins to move until it is normally closed or reaches a closed state. During the closing process, the car door or landing door gradually decreases a gap between the doors. The normal closing or closed state described herein means that the car door or landing door is completely closed without gaps or openings. It is noted that the gap described herein may refer to a gap between door bodies (when the door comprises a plurality of door bodies) or a gap between the door body and the door frame (when the door comprises only one door body).

In this specification, “automatic closing function of a landing door” refers to a function that causes the landing door to close, prohibits the opening of the landing door, or locks the landing door when an elevator system is in a specific state (e.g., when the car is in the stopped state and the landing door is completely closed). It should be noted that the implementation of the automatic closing function of the landing door is dependent on a cooperative operation of multiple levels and multiple components. For example, in the case of the landing door of the elevator system, a control device (e.g., a door controller or elevator controller) monitors the state of each landing door and the position of the car, and determines the timing of locking the landing door based on the monitoring information; for example, the door sensor or door lock switch is responsible for transmitting the state signal of the landing door (e.g., a door closing in place signal) to the control device; and for example, an executing mechanism is a key component that usually executes actions to close, lock, or unlock the landing door based on instructions from the control device. That is, any abnormal operation of any level or component may lead to an abnormal automatic closing function of the landing door.

The specific structure and working principle of the executing mechanism may vary depending on the elevator manufacturer and product model, and the executing mechanism usually includes components such as a spring device and/or a safety gear for ensuring normal operation of the self-locking function or the automatic closing function. For example, in a typical executing mechanism, when the landing door is in a closed state, the spring will apply a certain force to the landing door to drive it into a completely closed state and keep it tightly closed. The safety gear is another component of the executing mechanism, which may drive the landing door into a completely closed state and keep it locked when the car is in a stopped state. It should be noted that it is usually not necessary to configure a separate safety gear for each landing door; furthermore, a separate spring may be configured for each landing door, or a shared set of spring systems may be used to support multiple landing doors of the elevator system.

In some embodiments of the present application, a check of the automatic closing function of the landing door will be performed by causing the elevator system to enter an automatic check mode. The check of the automatic closing function of the landing door is described in detail below.

During a period when the elevator system is idle (e.g., a non-operational period), the car door is driven into a closing process. During the closing process, the landing door moves in the same direction under the drive of the car door. A drive mechanism such as an electric motor or hydraulic system may usually be used to provide the force or driving force used to drive the movement of the car door and the landing door. In addition to the driving force from the drive mechanism, the force applied to the landing door by the executing mechanism described above also plays an auxiliary role in the closing of the landing door. When the combined force of the driving force and the auxiliary force is large enough to overcome the resistance to which the car door and the landing door are subjected (e.g. the friction between the car door and the landing door and the door frame), the car door and the landing door are closed. As the car door and the landing door move, the gap of the car door and the gap of the landing door will be gradually reduced until it is completely closed or closed. Therefore, it may be determined whether the automatic closing function of the landing door is normal based on the result of whether the landing door is able to close completely or normally (the result may be obtained, for example, by a door closing in place signal).

In some embodiments, the magnitude of the driving force may be selected such that it corresponds to or is substantially equivalent to the resistance to which the car door is subjected (hereinafter, the driving force corresponding to the resistance to which the car door is subjected is referred to as the balanced driving force). When the balanced driving force is utilized to drive the car door, the external force to which the landing door is subjected is the combined force of the auxiliary force applied by the executing mechanism and the resistance to which the landing door is subjected; in such a case, if the automatic closing function of the landing door is normal, the landing door will ultimately enter into a completely closed or closed state, otherwise, the landing door will not be closed normally or enter into a completely closed state, whereby it may be judged based on the above result whether the automatic closing function of the landing door is normal. “Corresponding” and “substantially equivalent” as described herein means that the balanced driving force may take a value within a certain range near the resistance, as long as the deviation of this value from the resistance does not materially affect the result of the check of the automatic closing function of the landing door.

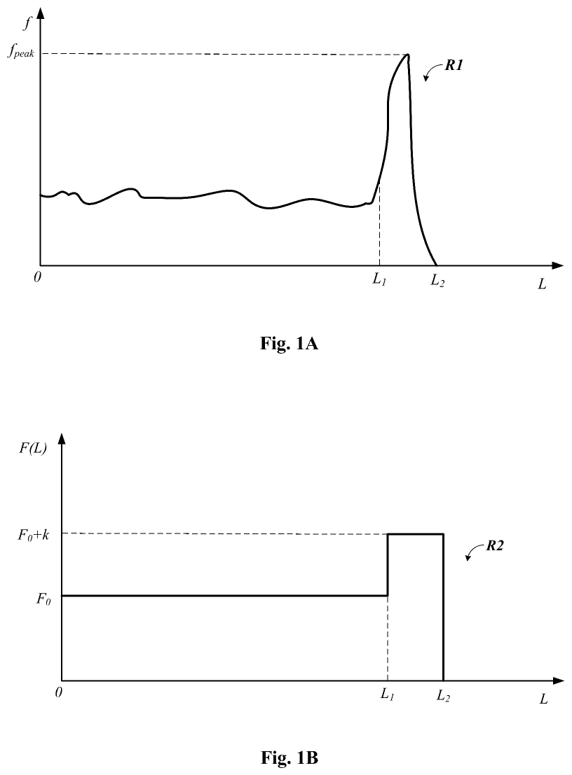

In some cases, the resistance to which the car door is subjected varies with its position. FIG. 1A exemplarily shows a relationship curve of resistance to which a car door is subjected versus its position, where the horizontal axis represents the position L of the car door (e.g., the distance between the edge of the car door and the door frame of the door body), and the vertical axis represents the resistance f to which the car door is subjected. As shown in FIG. 1A, during the movement of the car door from the zero point of the position coordinate (corresponding to the beginning of the closing process or the moment when the car door is completely open) to the position coordinate L1 (corresponding to the beginning of the action of the self-locking mechanism of the car door), the resistance f remains basically stable. During the movement of the car door from the position coordinate L1 to the position coordinate L2 (corresponding to the moment when the car door is in the completely closed state), the resistance f changes in a sharp peak shape. Although the shape of the relationship curve (e.g., a peak value fpeak of the sharp peak and a position interval ΔL (an interval between the position coordinate L1 and the position coordinate L2, etc.)) varies with the structure and working principle of the self-locking mechanism of the car door as well as with the environment in which the elevator system is applied, etc., this pattern of change in the resistance is similar.

In some embodiments, a relationship curve R2 of a balanced driving force versus a position of the car door may be determined from a relationship curve R1 of resistance to which the car door is subjected versus its position, and the balanced driving force may subsequently be adjusted according to the relationship curve R2 such that the balanced driving force applied at each car door position is substantially equivalent to the resistance to which the car door is subjected.

In some embodiments, the adjustment of the balanced driving force to follow the drastically varying resistance f begins only when the car door reaches a position at which its self-locking mechanism starts to act (e.g., position coordinate L1 in FIG. 1A). However, the drastic variation of the resistance f within the position interval ΔL makes it difficult, and even difficult to achieve, to allow the balanced driving force to follow the resistance. For this reason, in some embodiments, the balanced driving force may be made to stepwise jump within the position interval ΔL. Exemplarily, the balanced driving force F (L) may be determined by the following equation:

$$F ( L ) = \{ \begin{matrix}{F}_{0} , 0 \leq L < {L}_{1} \\ {F}_{0} + k , {L}_{1} \leq L \leq {L}_{2}\end{matrix} \qquad ( 1 )$$

In the above equation, L is the position coordinate of the car door, F0 and k are constants greater than 0, where F0 may for example be taken as the average value of the resistance f to which the car door is subjected within the position interval from 0 to L1, and k may be determined for example based on amount of change in the position of the car door during the act of the self-locking mechanism (e.g., the length of the position interval ΔL), amount of change in the position of the car door during the application of the balanced driving force (e.g., L2) or the distance traveled and the peak value fpeak of the resistance f within the position interval ΔL. FIG. 1B shows a relationship curve of a balanced driving force versus a position of the car door, where the horizontal axis represents the position L of the car door, and the vertical axis represents the balanced driving force F (L) applied to the car door. Referring to FIG. 1B, the relationship curve R2 shown follows a pattern of change defined by equation (1).

Exemplarily, the value of k may be determined using the following equation:

$$k = ∝ \frac{Δ L}{{L}_{2}} ( {f}_{p e a k} - {F}_{0} ) \qquad ( 2 )$$

The α in the above equation is a constant greater than 0, which may be determined experimentally.

Although the adjustment of the balanced driving force in the manner described above does not precisely follow the change in the resistance force f, the inventors of the present application have found after research that the effect of the adjustment method described above on the result of the check of the automatic closing function of the landing door is negligible. In addition, in the case of a drive mechanism such as a motor, the stepwise jump of the driving force greatly reduces the difficulty of implementation.

Various means may be used to determine the relationship between the resistance to which the car door is subjected and its position. For example, in some embodiments, it is possible to decouple the car door from the landing door mechanically (i.e., so that the landing door does not move under the drive of the car door), move the car door at a constant speed by controlling a driving force applied by the drive mechanism to the car door, and measure the driving force output by the drive mechanism under the constant-speed movement of the car door, so as to derive the resistance to which the car door is subjected. Subsequently, a relationship curve of resistance to which the car door is subjected versus the position of the car door (e.g., curve R1 shown in FIG. 1A) may be generated based on the applied driving force and the corresponding position of the car door, and a relationship curve of the balanced driving force versus the position of the car door (e.g., curve R2 shown in FIG. 1B) may be determined therefrom. In other embodiments, the relationship curve of the balanced driving force versus the position of the car door may be calibrated regularly or irregularly.

The position of the car door may be determined, for example, by deploying a pair of wireless signal transmitter and wireless signal receiver at the car door and the door frame and measuring the signal strength received by the wireless signal receiver. In addition, whether the self-locking mechanism of the car door has started to act may be determined based on a variety of signals. These signals include, for example, but are not limited to, a sensing signal from a sensor monitoring a movement of the self-locking mechanism, a current flowing through the self-locking mechanism and a signal from a position feedback device of the self-locking mechanism. As for the determination that the car door is in a completely closed state, this may be determined using a door closing in place signal of the elevator system.

It is generally recognized that an abnormality in the automatic closing function, regardless of the cause, results in the landing door not being able to close completely. However, even if the landing door is able to close completely, it cannot be ruled out that the automatic closing function may fail within a short period of time. In order to be able to detect such a potential risk of failure, in some embodiments of the present application, not only attention is paid to the ability of the landing door to be completely closed, but also time is introduced as a dimension to be examined, i.e., it is determined that the automatic closing function of the landing door is normal only if the landing door is able to enter a closed state within a preset time period since the start of outputting the balanced driving force by the drive mechanism.

The above-described preset time period may be determined based on the position and speed of movement of the landing door at the time of starting to apply the balanced driving force. In some embodiments, it is possible, for example, to couple the car door to the landing door (i.e., to cause the landing door to move under the drive of the car door), to drive the car door with the balanced driving force when the landing door reaches a certain position, and to measure the speed of movement of the landing door at this time (e.g., by using a speed sensor arranged on the landing door), the position (e.g., by means of the signal strength-based method as described above), and a length of time required for the landing door to be normally closed or completely closed from the beginning of applying the balanced driving force, provided that it has been verified that the automatic closing function of the landing door is normal. The above-described measurement method may be applied to a plurality of positions of the landing door, so as to obtain a calibration relationship between the speed of movement, the position of the landing door at the time of starting to apply the balanced driving force, and the length of time required for the landing door to be completely closed from the beginning of applying the balanced driving force. The length of time in the calibration relationship (hereinafter also referred to as the calibration length) may be used to set the preset time period. Specifically, when the check operation of the automatic closing function is performed, the corresponding calibration length is determined as a preset time period from the measurement signals of the position and speed of movement of the landing door at the time when the balanced driving force starts to be applied, utilizing the calibration relationship described above.

Although the balanced driving force may be applied at various moments of the closing process of the car door (e.g., at a moment when the car door begins to move or at a moment after the car door begins to move), in some embodiments, applying the balanced driving force at the beginning of the closing process of the landing door is advantageous for simplifying the implementation of the check operation of the automatic closing function. In particular, the studies of the inventors of the present application have shown that when the moment of application of the balanced driving force is the moment of the beginning of the closing process of the landing door, the initial speed of the landing door shows a high degree of repeatability and the time required for the landing door to reach the completely closed state is also highly consistent. As a result, a preset time period can be determined without measuring the speed and position of the landing door.

The above-described check operation of the automatic closing function is not only applicable to a single landing door, but is also applicable to a plurality of landing doors. For example, the automatic closing function of each landing door may be checked sequentially in the order of the list of landing doors to be maintained in accordance with the above-described checking method, and the checking results is stored, until all the landing doors have completed the check operation. It is to be noted that the order in which the check is performed may be various specified orders, such as a floor order including landing doors from the 1st floor to the nth floor or landing doors from the nth floor to the 1st floor, or an order obtained by randomly selecting from the landing doors of the 1st to the nth floors. In addition, the above checking method is also applicable in the case where a floor contains a plurality of landing doors, in which case a corresponding device identification may be assigned to each of the landing doors to distinguish the landing doors from each other.

In some embodiments, the stored checking results may be sent to cloud (e.g., via an IoT gateway to a remote server) or to a mobile terminal (e.g., via a Bluetooth channel or a mobile communication system to a mobile terminal such as a cell phone, a tablet, a portable computer, and a wearable device).

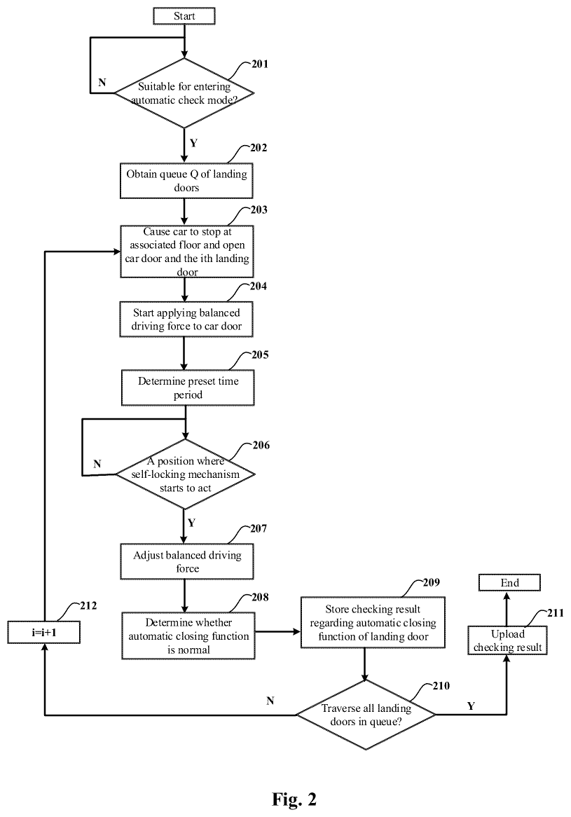

FIG. 2 is a flowchart of a method for detecting an automatic closing function of a landing door of an elevator system in accordance with some embodiments of the present application. The method described below may be implemented by various devices, which include, for example, but are not limited to, a control device (e.g., a door controller or an elevator controller) within an elevator system and a dedicated device for detecting an automatic closing function of a landing door, etc., and which are hereinafter collectively referred to as the device or the detection device for detecting the function of the elevator system.

The method shown in FIG. 2 begins at step 201. In this step, the detection device determines whether the elevator system is suitable for entering the automatic check mode at the current time. If it is suitable for entering the automatic check mode, it proceeds to step 202, otherwise, it continues to wait. Exemplarily, maintenance of the elevator system is usually performed during non-operational period, so the detection device may allow the elevator system to enter the automatic check mode when the current time is outside of the operational hours and there are no calls for the elevator.

At step 202, the detection device obtains a queue Q of landing doors to be performed for checking the automatic closing function of the landing door, the queue comprises one or more landing doors FDi, each landing door being associated with one of a plurality of floors (e.g., provide at an associated floor). In some embodiments, the order of floors (e.g. from the 1st floor to the nth floor or from the nth floor to the 1st floor) is used as the order in which checks are performed on the landing doors. However, it should be noted that this is not necessary and other checking orders may be used as needed for application scenarios (e.g., performing the checking only for landing doors on even or odd numbered floors, or performing the checking for landing doors that are used frequently). Exemplarily, the serial number i is used to indicate the order in which the check operation of the automatic closing function of the landing door is performed.

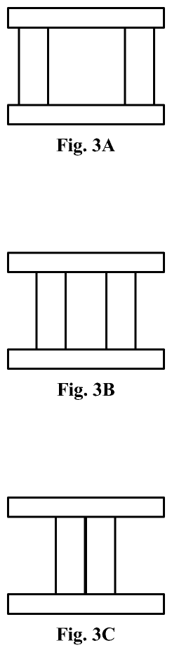

Then proceed to step 203, in which the detection device causes the car to stop at the floor associated with the ith landing door FDi (i=1 when the detection is started) in the queue Q of landing doors, i.e., the car stops stationary at that floor. Optionally, the detection device also causes the landing door and car door to be in an open state, as shown in FIG. 3A.

Next, at step 204, the detection device causes a drive mechanism (e.g., a motor) of the car door CD to start applying the balanced driving force to the car door (e.g., by causing a power source to supply power to the drive mechanism), thereby initiating a closing process of the car door and the ith landing door FDi. In practice, a driving force greater than the balanced driving force F0 may be applied during a short time interval (e.g. a few hundred milliseconds) at the beginning of the closing process to cause the car door drive the landing door to start moving, and subsequently to drive the car door CD with the balanced driving force F0. Although the driving force applied during the time interval at the beginning is not equal to the balanced driving force, it is reasonable to consider the balanced driving force as applied at the beginning of the closing process due to the short time interval. During the application of the balanced driving force F0 to the car door CD, the gap of the landing door FDi is continuously decreasing, as shown in FIG. 3B.

Then proceed to step 205, in which the detection device will determine a reference value or a preset time period for determining whether the automatic closing function is normal. As described above, the balanced driving force may be applied at various moments of the closing process of the car door. If the balanced driving force is applied at the beginning of the closing process, the preset time period may be determined without measuring the speed and position of the landing door. On the other hand, if the balanced driving force is applied to the car door during the closing process, the corresponding calibration length is determined as a preset time period from the position and speed of movement of the landing door measured at the time when the balanced driving force starts to be applied by utilizing a predetermined calibration relationship.

In step 206, the detection device determines whether the car door reaches a position (e.g., the position coordinate L1 in FIG. 1A) at which its self-locking mechanism starts to act, for example, based on one or more of a sensing signal from a sensor monitoring a movement of the self-locking mechanism, a current flowing through the self-locking mechanism and a signal from a position feedback device of the self-locking mechanism. If the car door reaches the position, proceed to step 207, otherwise it continues to determine whether the car door reaches the position.

In step 207, the detection device begins to adjust the balanced driving force. The adjustment method has been described above and will not be repeated here.

The process shown in FIG. 2 proceeds to step 208 after step 207. In this step, the detection device determines whether the automatic closing function of the landing door FDi is normal based on the closing behavior of the landing door FDi. Specifically, if the landing door FDi can be closed normally (e.g., as shown in FIG. 3C) within a preset time period since the start of applying the balanced driving force to the car door CD, it is determined that the automatic closing function of the landing door FDi is normal, otherwise, it is determined that the automatic closing function of the landing door FDi is abnormal. Exemplarily, it may be determined whether the landing door FDi is closed completely with the aid of the door closing in place signal of the elevator system.

Then proceed to step 209, in which the detection device stores the checking result regarding the automatic closing function of the landing door FDi.

Subsequently, in step 210, the detection device determines whether the checking of the automatic closing function of the landing door has been completed for all landing doors in the queue Q. If all landing doors in the queue Q are traversed, it proceeds to step 211, and otherwise, it proceeds to step 212.

At step 211, the detection device sends the checking results regarding the automatic closing function of each landing door stored in step 209 to the cloud or the mobile terminal.

At step 212, the detection device increments the serial number of the landing door (i=i+1) to cause the operation object of the subsequent step to be updated to the next landing door in the queue Q. After completing step 212, the method flow shown in FIG. 2 returns to step 203 so as to perform the check operation of the automatic closing function of the landing door for other landing doors in the queue Q.

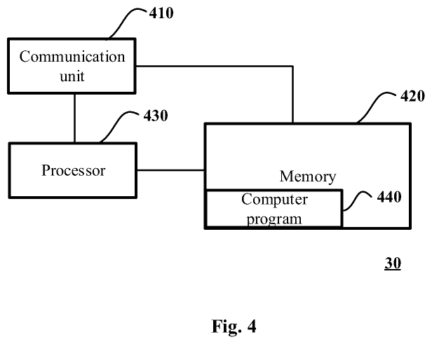

FIG. 4 is a schematic block diagram of a device or detection device for detecting an automatic closing function of a landing door of an elevator system in accordance with some other embodiments of the present application. The detection device shown in FIG. 4 may be used to implement the method shown in FIG. 2.

As shown in FIG. 4, a detection device 40 comprises a communication unit 410, a memory 420 (e.g., a non-volatile memory such as a flash memory, a ROM, a hard drive, a disk, an optical disc), a processor 430, and a computer program 440.

The communication unit 410 (e.g., a network interface card) serves as a communication interface configured to establish a communication connection between the detection device and an external device (e.g., a drive mechanism of a car door, a sensor that monitors the movement or current of a self-locking mechanism, a position feedback device of the self-locking mechanism, etc.) or a network (e.g., Internet and a wireless local area network, etc.).

The memory 420 (e.g., RAM) stores the computer program 440 that may be executed by the processor 430 (e.g., a microprocessor). In addition, the memory 420 may store data generated by the processor 430 in execution of the computer program 440 and data received from the external device via the communication unit 410 (e.g., a queue Q of landing doors to be performed for checking the automatic closing function and a checking result regarding the automatic closing function, etc.).

The processor 430 is configured to run the computer program 440 stored on the memory 420 and to perform access operations to the memory 420 (e.g., obtaining the queue Q of landing doors and storing the checking result regarding the automatic closing function in the memory 420).

The computer program 440 may include computer instructions for implementing a method described with the aid of FIG. 2, enabling implementation of the corresponding method when the computer program 440 is run on the processor 430.

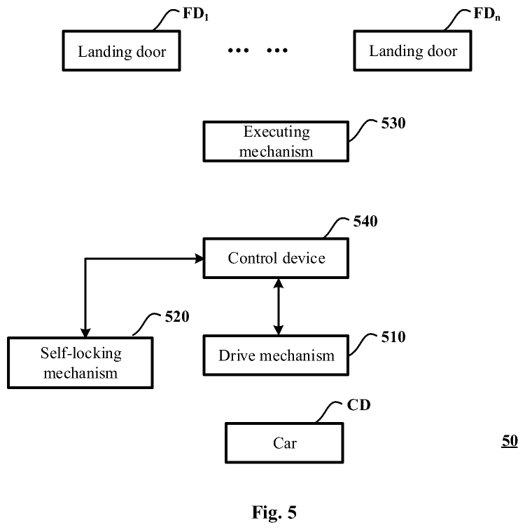

FIG. 5 is a schematic block diagram of an elevator system in accordance with some other embodiments of the present application.

An elevator system 50 shown in FIG. 5 includes landing doors FD1 to FDn provided at a plurality of floors having an automatic closing function of a landing door, a car CD, a drive mechanism 510 for driving the movement of the car, a self-locking mechanism 520 of the car door, an executing mechanism 530 (e.g., an interlock or motor) for implementing the automatic closing function of the landing door, and a control device (e.g., a processor-based door controller or a processor-based elevator controller) 540.

Referring to FIG. 5, the control device 540 is coupled with the drive mechanism 510, the self-locking mechanism 520, which has one or more features of the detection device shown in FIG. 4, so as to perform the check operation of the automatic closing function of the landing door described in detail above.

Those skilled in the art will appreciate that various illustrative logical blocks, modules, circuits, and algorithm steps described herein may be implemented as electronic hardware, computer software, or combinations of both.

To demonstrate this interchangeability between the hardware and software, various illustrative components, blocks, modules, circuits, and steps have been described above generally in terms of their functionality. Whether such functionality is implemented in hardware or software depends on the particular application and design constraints imposed on the overall system. Those skilled in the art may implement the described functionality in changing ways for the particular application. However, such implementation decisions should not be interpreted as causing a departure from the scope of the present application.

Although only a few of the specific embodiments of the present application have been described, those skilled in the art will appreciate that the present application may be embodied in many other forms without departing from the spirit and scope thereof. Accordingly, the examples and implementations shown are to be regarded as illustrative and not restrictive, and various modifications and substitutions may be covered by the application without departing from the spirit and scope of the application as defined by the appended claims.

The embodiments and examples presented herein are provided to best illustrate embodiments in accordance with the present technology and its particular application, and to thereby enable those skilled in the art to implement and use the present application. However, those skilled in the art will appreciate that the above description and examples are provided for convenience of illustration and example only. The presented description is not intended to cover every aspect of the application or to limit the application to the precise form disclosed.

What is claimed is:

1. A method for detecting an automatic closing function of a landing door, the method comprising:
A. when a car of an elevator system stops at one of a plurality of floors, opening a car door of the car and a landing door associated with one of the plurality of floors;
B. causing a drive mechanism of the elevator system to apply a balanced driving force to the car door of the car during a closing process of the landing door, wherein the balanced driving force corresponds to resistance to which the car door is subjected; and
C. determining whether the associated landing door can be closed normally within a preset time period since starting to apply the balanced driving force to the car door.

2. The method of claim 1, further comprising: performing operations A through C in a specified order for landing doors associated with one or more other floors of the plurality of floors.

3. The method of claim 1, further comprising: sending a detection report on the automatic closing function of the landing door of the one or more landing floors to cloud or a mobile terminal.

4. The method of claim 1, further comprising: determining whether the elevator system is adapted to enter or be in a test mode, and if so, performing operations A through C.

5. The method of claim 1, wherein the balanced driving force is adjusted based on a position of the car door during applying the balanced driving force to the car door.

6. The method of claim 5, wherein the balanced driving force is adjusted only after the car door reaches a position at which its self-locking mechanism starts to act.

7. The method of claim 6, wherein the balanced driving force is adjusted in such a way that the balanced driving force makes a stepwise jump, magnitude of the jump being determined based on amount of change in the position of the car door and peak value of the resistance to which the car door is subjected during the acting of the self-locking mechanism, amount of change in the position of the car door during applying the balanced driving force.

8. The method of claim 5, further comprising: obtaining a relationship curve between the balanced driving force and the position of the car door.

9. The method of claim 8, wherein the relationship curve is determined in the following manner:
decoupling the car door from the landing door mechanically;
causing the car door to move at a constant speed by controlling a driving force applied by the drive mechanism to the car door; and
obtaining the relationship curve based on the applied driving force and the corresponding position of the car door.

10. The method of claim 8, wherein the relationship curve is calibrated regularly or irregularly.

11. The method of claim 6, wherein determining whether the self-locking mechanism starts to act is based on at least one of: a sensing signal from a sensor monitoring a movement of the self-locking mechanism, a current flowing through the self-locking mechanism and a signal from a position feedback device of the self-locking mechanism.

12. The method of claim 1, wherein the preset time period is determined based on speed of movement and position of the landing door at the beginning of applying the balanced driving force.

13. The method of claim 1, wherein the balanced driving force is applied from the start of the closing process or from a moment after the start of the closing process.

14. A device for detecting an automatic closing function of a landing door of an elevator system, the device comprising:
a memory;
a processor coupled with the memory; and
a computer program stored on the memory and running on the processor, the running of the computer program causing the following operations:
A. when a car of the elevator system stops at one of a plurality of floors, opening a car door of the car and a landing door associated with one of the plurality of floors;
B. causing a drive mechanism of the elevator system to apply a balanced driving force to the car door of the car during a closing process of the landing door, wherein the balanced driving force corresponds to resistance to which the car door is subjected; and
C. determining whether the associated landing door can be closed normally within a preset time period since the start of applying the balanced driving force to the car door.

15. The device of claim 14, wherein the running of the computer program also causes the further operation: performing operations A through C in a specified order for landing doors associated with one or more other floors of the plurality of floors.

16. The device of claim 14, wherein the device is a door controller or an elevator controller.

17. The device of claim 14, wherein the running of the computer program also causes the further operation:
sending a detection report on the automatic closing function of the landing door to cloud or a mobile terminal.

18. The device of claim 14, wherein the running of the computer program also causes the further operation: determining whether the elevator system is adapted to enter or be in a test mode, and if so, performing the operations A through C.

19. The device of claim 14, wherein the running of the computer program causes the balanced driving force to be adjusted based on a position of the car door during applying the balanced driving force to the car door.

20. The device of claim 19, wherein the running of the computer program also causes the balanced driving force to be adjusted only after the car door reaches a position at which its self-locking mechanism starts to act.

21. The device of claim 20, wherein the balanced driving force is adjusted in such a way that the balanced driving force makes a stepwise jump, magnitude of the jump being determined based on amount of change in the position of the car door and peak value of the resistance to which the car door is subjected during the acting of the self-locking mechanism, amount of change in the position of the car door during applying the balanced driving force.

22. The device of claim 19, wherein the running of the computer program also causes the further operation: obtaining a relationship curve between the balanced driving force and the position of the car door.

23. The device of claim 22, wherein the relationship curve is determined in the following manner:
decoupling the car door from the landing door mechanically;
causing the car door to move at a constant speed by controlling a driving force applied by the drive mechanism to the car door; and
obtaining the relationship curve based on the applied driving force and the corresponding position of the car door.

24. The device of claim 22, wherein the relationship curve is calibrated regularly or irregularly.

25. The device of claim 20, wherein determining whether the self-locking mechanism starts to act is based on at least one of: a sensing signal from a sensor monitoring a movement of the self-locking mechanism, a current flowing through the self-locking mechanism and a signal from a position feedback device of the self-locking mechanism.

26. The device of claim 14, wherein the preset time period is determined based on speed of movement and position of the landing door at the beginning of applying the balanced driving force.

27. The device of claim 14, wherein the running of the computer program causes the balanced driving force to be applied from the start of the closing process or from a moment after the start of the closing process.

28. An elevator system comprising:
landing doors provided at a plurality of floors having an automatic closing function of a landing door;
a car;
a drive mechanism; and
a control device comprising:
a memory;
a processor coupled with the memory; and
a computer program stored on the memory and running on the processor, the running of the computer program resulting in the following operations:
A. when a car of the elevator system stops at one of a plurality of floors, opening a car door of the car and a landing door associated with one of the plurality of floors;
B. causing a drive mechanism of the elevator system to apply a balanced driving force to the car door of the car during a closing process of the landing door, wherein the balanced driving force corresponds to resistance to which the car door is subjected; and
C. determining whether the associated landing door can be closed normally within a preset time period since the start of applying the balanced driving force to the car door.

29. A non-transitory computer-readable storage medium, the computer-readable storage medium having instructions stored therein, characterized in that when the instructions are executed by a processor, the processor performs the method of claim 1.
